(19) United States
(12) Patent Application Publication
(10) Pub. No.: US 2006/0237130 A1
(43) Pub. Date: Oct. 26, 2006

(54) ACOUSTIC WEB

(75) Inventor: Delton R. Thompson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/423,985

(22) Filed: Jun. 14, 2006

Related U.S. Application Data
(62) Division of application No. 10/335,752, filed on Jan. 2, 2003.

(51) Int. Cl. B32B 37/00

(52) U.S. Cl. 156/273.3

(57) ABSTRACT

Pore plugging is reduced when laminating an airflow resistive membrane to a thermoplastic hot melt adhesive, by treating the membrane to reduce its surface energy. This enables fabrication of acoustical laminates incorporating substantial amounts of recycled fibrous insulating mat manufacturing waste, and permits design of the laminate based primarily on one-quarter wavelength sound absorption considerations and control of the porosity and interfacial adhesion of the airflow resistant membrane.

### CROSS-REFERENCE TO RELATED APPLICATION

This is a divisional of U.S. patent application Ser. No. 10/335,752, filed Jan. 2, 2003, the entire disclosure of which is incorporated herein by reference.

### FIELD

This invention relates to sound absorptive articles and methods for their preparation.

### BACKGROUND

Typical insulating mat substrates may employ air laid nonwoven polyester fibers bound with adhesive bicomponent fibers, open- or closed-cell foam sheets, or resinated shoddy mats. If made in a porous structure and with a suitable thickness, these substrates can absorb sound and thereby reduce noise levels in nearby spaces. For example, porous insulating mat substrates can be laminated to carpeting, headliners, trunk liners, hood liners, interior panels, and other porous decorative or functional facings such as those employed in vehicles, in order to provide enhanced noise reduction compared to use of the facing by itself.

Typical vehicular carpet laminates have a fibrous face of nylon or other synthetic tufted into a high basis weight supporting layer made of nylon or other compatible synthetic. The supporting layer backside is typically extrusion coated with a molten hot melt adhesive or calcium carbonate-loaded latex to fix the fiber tufts. Optionally, a hot melt adhesive may be applied as a thin primary backcoat followed by a heavy latex secondary backcoat. The resulting backed carpet can be applied over an insulating mat. To form a vehicular carpet laminate, the backed carpet and the insulating mat typically are preheated followed by compression molding. The backcoat adhesively bonds the carpet to the mat. The resulting laminate is subsequently air quenched and water jet cut to yield the final vehicular part.

For applications involving noise reduction, latex carpet backings typically are omitted in favor of hot melt adhesive primary backings. Calcium carbonate-loaded lattices typically are sufficiently thick and impermeable to prevent the passage of sound waves through the backing and into the insulating mat, thus limiting the available noise reduction. Hot melt adhesive backings typically may be continuous and impervious when applied, but become porous during lamination of the backing to the insulating mat due to capillary flow of the adhesive into the carpet or into the mat. Polyolefins such as low density polyethylene (“LDPE”) are often used as the hot melt adhesive.

When an airflow resistive membrane is positioned between a carpet and an insulating mat, improved sound insulating performance can be obtained, see e.g., M. Schwartz and E. J. Gohmann, Jr., “Influence of Surface Coatings on Impedance and Absorption of Urethane Foams, J. Acoust. Soc. Am., 34 (4): 502-513 (April, 1962), M. Schwartz and W. L. Buehner, “Effects of Light Coatings on Impedance and Absorption of Open-Celled Foams, J, Acoust. Soc. Am., 35 (10): 1507-1510 (October, 1963), U.S. Pat. Nos. 5,459,291, 5,824,973, 6,145,617, 6,217,691, 6,270,608 and 6,296,075, U.S. Published Patent Application No. US 2001/0036788 A1 and PCT Published Application Nos. WO 99/44817 A1, WO 00/27671 A1, WO 01/64991 A2 and WO 02/20307 A1.

### SUMMARY OF THE INVENTION

Airflow resistive membranes can experience partial or even substantially complete pore plugging when molded or laminated against a carpet or other decorative or functional object backed with a hot melt adhesive. Pore plugging can be exacerbated when the hot melt adhesive has a lower surface energy than the surface energy of the membrane. Meltblown webs made of polyamide (e.g., Nylon 6) or polyester (e.g., polybutylene terephthalate) are especially useful airflow resistive membrane materials, but are susceptible to plugging by molten polyolefin. The low surface energy molten polyolefin readily wets the higher surface energy polyamide or polyester membrane material, can flow into pores or other interstices in the membrane, and may fill the pores and saturate the membrane when cooled. This can undesirably reduce porosity and sound absorption performance, although it may also increase interfacial adhesion.

The above-mentioned PCT Published Application No. WO 00/2767 A1 describes a vehicle roof lining that includes a porous barrier layer said to be made of a material that prevents the migration of adhesive components. This Application states that the barrier layer's surface areas can be treated to promote wettability of adhesives coming into contact with the surface, while the barrier layer's core could repel adhesives. Such a treatment presumably would involve increasing the surface energy at the barrier's surface to promote such wettability.

The present invention provides, in one aspect, a method for laminating an adhesive layer to a semipermeable airflow resistive membrane, comprising treating the airflow resistive membrane to reduce its surface energy before laminating the adhesive layer to the membrane.

The invention also provides a method for making a sound-modifying structure comprising:
a) providing a stack of layers comprising a decorative facing layer, a thermoplastic adhesive layer, a porous membrane that has been treated to render the membrane substantially impenetrable by molten polyethylene, and a layer of fibrous material, and
b) laminating the stack of layers together under sufficient heat and pressure to form a unitary porous sound-modifying, structure.

The invention also provides a method for attenuating sound waves passing from a source area to a receiving area of a vehicle, comprising:
a) providing an acoustical laminate comprising a fibrous or open cell foam underlayment, a hot melt adhesive layer, a porous membrane that has been treated to render the membrane substantially impenetrable by molten polyethylene a hot melt adhesive layer, and a decorative layer; and
b) positioning the laminate between the source area and the receiving area such that a major face of the laminate intercepts and thereby attenuates sound waves passing from the source area to the receiving area.

The invention also provides a porous laminate comprising a discontinuous hot melt adhesive layer adhered to a semipermeable low surface energy airflow resistive porous layer whose pores are substantially impenetrable by the adhesive.

The invention also provides a porous laminate comprising a thermoplastic adhesive layer adjacent to a semipermeable fluorochemically-treated airflow resistive membrane.

The invention further provides a sound-absorbing laminate having a porous sound-absorbing spacing layer adjacent to a semipermeable airflow resistive membrane that is substantially impenetrable by molten polyethylene.

In a further embodiment, the invention provides a sound-modifying structure comprising a sound-reflecting surface spaced from a semipermeable sound modifying laminate comprising a facing layer and a porous membrane that is substantially impenetrable by molten polyethylene.

In another embodiment, the invention provides a vehicular sound-absorbing, structure comprising a decorative layer backcoated with a discontinuous hot melt adhesive layer adhered to a fluorochemically-treated nonwoven airflow resistive membrane having an airflow resistance between 50 and 5000 mks Rayls.

In yet another embodiment, the invention provides a carpet comprising fibers tufted into a backing backcoated with a discontinuous hot melt adhesive layer adhered to a fluorochemically-treated nonwoven airflow resistive membrane having an airflow resistance between 50 and 5000 mks Rayls.

In another embodiment, the invention provides an acoustical laminate comprising:
a) a fibrous or open cell foam underlayment,
b) a hot melt adhesive layer,
c) a fluorochemically-treated nonwoven airflow resistive membrane having an airflow resistance between 50 and 5000 mks Rayls,
d) a hot melt adhesive layer, and
e) a decorative layer.

### BRIEF DESCRIPTION OF THE DRAWING

FIG. 1 is a perspective view of a carpet bonded to an airflow resistive membrane and insulating mat, with the carpet and membrane being partly peeled away to better illustrate individual layers.

FIG. 2 is an enlarged top view of the airflow resistive membrane of FIG. 1.

FIG. 3 is a schematic side view of a carpet bonded to an airflow resistive membrane and insulating mat.

FIG. 4 is a photograph comparing fluorochemically-treated and nonfluorochemically-treated membranes in automotive carpet laminates that have been pulled apart to expose the membrane-carpet interface.

### DETAILED DESCRIPTION

In the practice of the present invention, the word “semipermeable” refers to a membrane having an acoustical airflow resistance between about 50 and about 5000 mks Rayls when evaluated using ASTM C522. The phrase “low surface energy” refers to a surface whose surface energy is less than about 34 dynes/cm². The phrase “hot melt adhesive” refers to a thermoplastic material having a melting point and adhesive strength over a range of temperatures suitable for use in assembling acoustic laminates for vehicular applications.

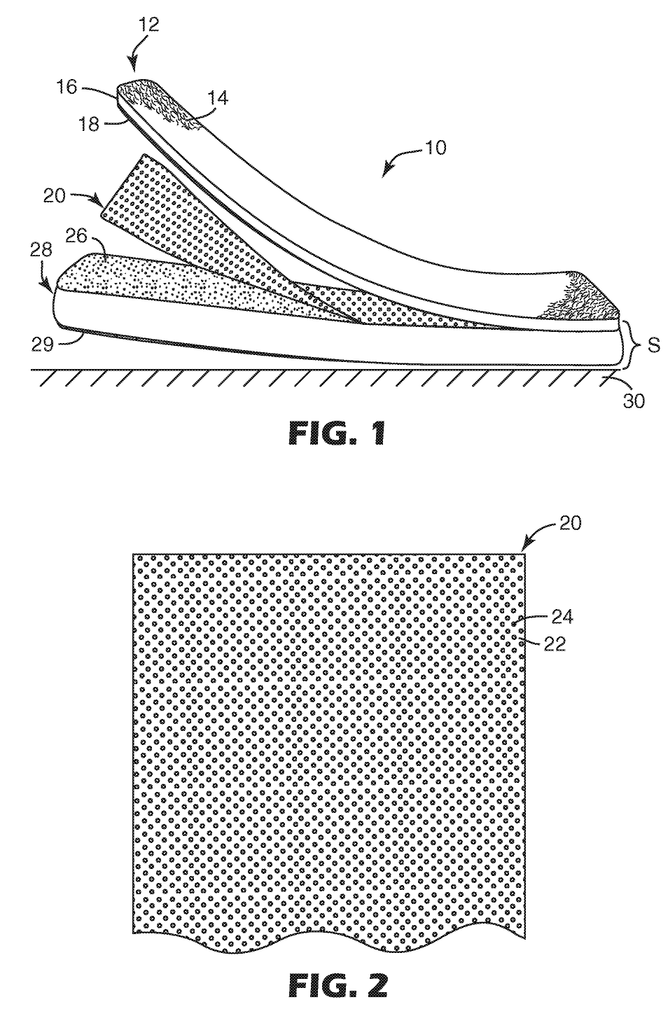

FIG. 1 is a perspective view of an acoustical laminate 10. Laminate 10 includes carpet 12 made from nylon fibers 14 tufted into nylon spunbond fabric 16 and backcoated with LDPE hot melt adhesive layer 18. Layer 18 bonds carpet 12 to airflow resistive nylon meltblown fiber membrane 20. Membrane 20 is shown in an enlarged top view in FIG. 2, and includes a porous nonwoven portion 22 interspersed with generally nonporous embossed regions 24. Embossed regions 24 can improve the tensile strength of membrane 24. Referring again to FIG. 1, membrane 20 is bonded by discontinuous LDPE hot melt adhesive layer 26 to a nonwoven insulating mat 28 whose thickness provides a space S between carpet 12 and sound-reflecting surface 30. Mat 28 is bonded to surface 30 via a suitable adhesive layer 29. Mat 28 preferably is compressible and lightweight but sufficiently resilient so that mat 28 will move back into place if a force is applied to and then removed from carpet 12. As shown in FIG. 1, carpet 12, membrane 20 and mat 28 have been partly peeled away from surface 30 to better illustrate the various layers in acoustical laminate 10.

A variety of airflow resistive membranes can be used in the invention. The membrane is semipermeable and thus as indicated above has an acoustical airflow resistance between about 50 and about 5000 mks Rayls. Preferred membranes have an acoustical airflow resistance of at least about 200 mks Rayls. Preferred membranes also have an acoustical airflow resistance less than about 3300 mks Rayls. More preferably, the membrane has an acoustical airflow resistance of at least about 600 mks Rayls. Most preferably, the membrane also has an acoustical airflow resistance less than about 1100 mks Rayls. The airflow resistive membrane is treated so that it has a low surface energy, viz, less than that of the hot melt adhesive, and preferably less than about 34 dynes/cm², more preferably less than about 30 dynes/cm², and most preferably less than about 28 dynes/cm². Preferably the airflow resistive membrane has an elongation to break sufficient to enable the membrane to survive deep cavity molding (e.g., at least about 20%), and a thermal resistance sufficient to withstand the rigors of high temperature molding processes (e.g., at least about 210° C.). Lightweight meltblown nonwoven membranes having basis weights less than 300 g/m² are especially preferred, more preferably less than about 100 g/m² and most preferably less than about 70 g/m². Stiff or flexible membranes can be employed, with flexible membranes being especially preferred for carpet applications. For example, the membrane can have a bending stiffness B as low as 0.005 Nm or less when measured according to ASTM D1388 using Option A. The selection and processing of suitable membrane materials will be familiar to those skilled in the art. Preferred membrane materials include polyamides, polyesters, polyolefins and the materials disclosed in U.S. Pat. Nos. 5,459,291, 5,824,973, 6,145,617 and 6,296,075, U.S. Published Patent Application No. US 2001/0036788 A1 and PCT Published Application No. WO 99/44817 A1. Nylon 6 polyamide and polybutylene terephthalate are especially preferred membrane materials.

The surface energy of the airflow resistive web can be reduced in a variety of ways, e.g., by topically applying a suitable fluorochemical (e.g., an organofluorocarbon or fluorosilicone) or organosilicone treatment using spraying, foaming, padding or any other convenient method; by melt addition of a suitable fluorochemical (e.g., those just listed) to the extrusion or meltblowing die when the membrane is formed; or via plasma fluorination treatment. Topical fluorochemical treatments and fluorochemical melt additives are presently preferred. The fluorine add-on rate preferably is adjusted to provide the desired reduction in membrane surface energy and pore clogging during lamination while minimizing overall use of fluorine. In general comparable fluorine add-on rates can the used for topical and melt addition since for melt addition the fluorochemical typically will migrate to the membrane's surface. The amount of fluorochemical add-on rate can be evaluated by measuring the surface energy of the membrane or by analyzing the fluorine content at the membrane's surface before or preferably after assembly of the acoustical laminate. The fluorine content after assembly preferably is obtained after the layers of the assembled acoustical laminate have been manually pulled apart to expose the bond interfaces between individual layers. Preferred fluorochemical add-on rates are about 0.01 wt. % or more solids, and more preferably at about 0.3 to about 0.6 wt. % solids based on the membrane weight. Expressed on the basis of fluorine, the fluorochemical add-on rate preferably provides about 0.04 wt. % or more fluorine on the membrane, more preferably about 0.12 to about 0.24 wt. % fluorine. Melt application is especially preferred, as it may avoid capital costs for padding, drying or curing equipment and the associated processing steps that may be required for topical treatments.

Particularly preferred fluorochemicals for topical application include dispersions or solutions of fluorinated urethane compounds comprising the reaction product of:
a) a fluorinated polyether having the formula:
   R_{f}-Q-Tₖ (I)
wherein R_{f} represents a monovalent perfluorinated polyether group having a molecular weight of at least 750 g/mol, Q represents a chemical bond or a divalent or trivalent organic linking group, T represents a functional group capable of reacting with an isocyanate and k is 1 or 2;
b) an isocyanate component selected from a polyisocyanate compound that has at least 3 isocyanate groups or a mixture of polyisocyanate compounds wherein the average number of isocyanate groups per molecule is more than 2; and
c) optionally one or more co-reactants capable of reacting with an isocyanate group.

The perfluorinated polyether group R_{f} preferably has the formula:
R¹_{f}—O—R²_{f}—(R³_{f})_{q}— (II)
wherein R¹_{f} represents a perfluorinated alkyl group, R²_{f} represents a perfluorinated polyalkyleneoxy group consisting of perfluorinated alkyleneoxy groups having 1, 2, 3 or 4 carbon atoms or a mixture of such perfluorinated alkyleneoxy groups, R³_{f} represents a perfluorinated alkylene group and q is 0 or 1. The perfluorinated alkyl group R¹ _{f} in formula (II) may be linear or branched and preferably has 1 to 10 carbon atoms, more preferably 1 to 6 carbon atoms. A typical such perfluorinated alkyl group is CF₃—CF₂—CF₂—. The perfluoroalkyleneoxy group R²_{f} may be linear or branched. When the perfluoroalkyleneoxy group is composed of a mixture of different perfluoroalkyleneoxy units, the units can be present in a random configuration, an alternating configuration or as blocks. Typical perfluorinated polyalkyleneoxy groups R²_{f} include —CF_{2 —}CF₂—O—, —CF(CF₃)—CF₂—O—, CF₂—CF(CF₃)—O—, —CF₂—CF₂—CF₂—O—, —CF₂—O—, —CF(CF₃)—O—, —CF₂—CF₂—CF₂—CF₂—O, —[CF₂—CF₂—O]ᵣ—, —[CF(CF₃)—CF₂—O]ₙ—, —[CF₂CF₂—O]ᵢ—[CF₂O]ⱼ— and —[CF₂—CF₂—O]ₗ—[CF(CF₃)—CF₂—O]ₘ—, wherein r is 4 to 25, n is 3 to 25 and i, l, m and j each are 2 to 25. The perfluorinated alkylene group R³_{f} may be linear or branched and preferably has 1 to 6 carbon atoms. A typical such perfluorinated alkylene group is —CF₂— or —CF(CF₃)—. Examples of linking groups Q in formula (I) include organic groups that comprise aromatic or aliphatic groups that may be interrupted by O, N or S, e.g., alkylene groups, oxy groups, thio groups, urethane groups, carboxy groups, carbonyl groups, amido groups, oxyalkylene groups, thioalkylene groups, carboxyalkylene and/or an amidoalkylene groups. Examples of functional groups T in formula (I) include thiol, hydroxy and amino groups.

In a preferred embodiment, the fluorinated polyether of formula (I) has the formula:
R¹_{f}—[CF(CF₃)—CF₂O]ₙ—CF(CF₃)-A-Q-Tₖ (III)
wherein R¹_{f}, Q, T and k are as defined above, n is an integer of 3 to 25 and A is a carbonyl group or CH₂. An especially preferred fluorinated polyether of formula (III) contains an R¹_{f} group of the formula CF₃—CF₂—CF₂—O—, and thus contains a moiety of the formula CF₃—CF₂—CF₂—O—[CF(CF₃)—CF₂O]ₙ, —CF(CF₃)— where n is an integer of 3 to 25. This moiety has a molecular weight of 783 when n equals 3.

Representative examples of the moiety -A-Q-Tₖ in formula (III) include:
1. —CONR^{a}—CH₂CHOHCH₂OH wherein R^{a} is hydrogen or an alkyl group of for example 1 to 4 carbon atoms;
2. —CONH-1,4-dihydroxyphenyl;
3. —CH₂OCH₂CHOHCH₂OH;
4. —COOCH₂CHOHCH₂OH; and
5. —CONR^{b}—(CH₂)ₘOH where R^{b} is hydrogen or an alkyl group such as methyl, ethyl, propyl, butyl, or hexyl and m is 2, 3, 4, 6, 8, 10 or 11.
   Especially preferred fluorinated polyethers of formula (III) contain -A-Q¹-Tₖ moieties of the formula —CO—X—R^{c}(OH)ₖ wherein k is as defined above, R^{c} is an alkylene group of 1 to 15 carbon atoms and X is O or NR^{d} with R^{d} representing hydrogen or an alkyl group of 1 to 4 carbon atoms.

Preferred compounds according to formula (III) can be obtained by oligomerization of hexafluoropropylene oxide, yielding a perfluoropolyether carbonyl fluoride. This carbonyl fluoride may be converted into an acid, ester or alcohol by reactions well known to those skilled in the art. The carbonyl fluoride or acid, ester or alcohol derived therefrom may then be reacted further to introduce the desired isocyanate reactive groups T according to known procedures. Compounds having the -A-Q-Tₖ moiety 1 listed above can be obtained by reacting the methyl ester derivative of a fluorinated polyether with 3-amino-2-hydroxy-propanol. Compounds having the -A-Q-Tₖ moiety 5 listed above can be obtained in a similar way by using an amino-alcohol that has only one hydroxy function. For example, reaction with 2-aminoethanol would yield a compound having the group 5 listed above with R^{b} being hydrogen and m being 2. European Patent Application No. EP 0 870 778 also describes methods for producing compounds according to formula (III) having desired moieties -A-Q¹-Tₖ. Still further examples of compounds according to formula (I) or (III) are disclosed in U.S. Pat. No. 3,536,710.

The above-mentioned isocyanate component preferably is a polyisocyanate having at least 3 isocyanate groups or a mixture of polyisocyanate compounds that on average has more than 2 isocyanate groups per molecule such as for example a mixture of a diisocyanate compound and a polyisocyanate compound having 3 or more isocyanate groups. The polyisocyanate compound may be aliphatic or aromatic and is conveniently a non-fluorinated compound. Generally, the molecular weight of the polyisocyanate compound will be not more than 1500 g/mol. Examples include hexamethylenediisocyanate; 2,2,4-trimethyl-1,6-hexamethylenediisocyanate; 1,2-ethylenediisocyanate; dicyclohexylmethane-4,4′-diisocyanate; aliphatic triisocyanates such as 1,3,6-hexamethylenetriisocyanate, cyclic trimers of hexamethylenediisocyanate and cyclic trimers of isophorone diisocyanate (isocyanurates); aromatic polyisocyanates such as 4,4′-methylenediphenylenediisocyanate, 4,6-di-(trifluoromethyl)-1,3-benzene diisocyanate, 2,4-toluenediisocyanate, 2,6-toluene diisocyanate, o, m, and p-xylylene diisocyanate, 4,4′-diisocyanatodiphenylether, 3,3 t-dichloro-4,4′-diisocyanatodiphenylmethane, 4,5′-diphenyldiisocyanate, 4,4′-diisocyanatodibenzyl, 3,3′-dimethoxy-4,4′-diisocyanatodiphenyl, 3,3′-dimethyl-4,4′-diisocyanatodiphenyl, 2,2′-dichloro-5,5′-dimethoxy-4,4′-diisocyanato diphenyl, 1,3-diisocyanatobenzene, 1,2-naphthylene diisocyanate, 4-chloro-1,2-naphthylene diisocyanate, 1,3-naphthylene diisocyanate, and 1,8-dinitro-2,7-naphthylene diisocyanate and aromatic triisocyanates such as polymethylenepolyphenylisocyanate. Still further isocyanates that can be used for preparing the fluorinated urethane compound include alicyclic diisocyanates such as 3-isocyanatomethyl-3,5,5-trimethylcyclohexylisocyanate; aromatic tri-isocyanates such as polymethylenepolyphenylisocyanate (PAPI) and cyclic diisocyanates such as isophorone diisocyanate (IPDI). Also useful are isocyanates containing internal isocyanate-derived moieties such as biuret-containing tri-isocyanates such as DESMODUR™ N-100 (commercially available from Bayer), isocyanurate-containing tri-isocyanates such IPDI-1890 (commercially available from Huls AG), and azetedinedione-containing diisocyanates such as DESMODUR™ TT (commercially available from Bayer). Also, other di- or tri-isocyanates such as DESMODUR™ L and DESMODUR™ W (both commercially available from Bayer), tri-(4-isocyanatophenyl)-methane (commercially available from Bayer as DESMODUR™ R) and DDI 1410 (commercially available from Henkel) are suitable.

The above-mentioned optional coreactant includes substances such as water or a non-fluorinated organic compound having one or more Zerewitinoff hydrogen atoms. Examples include non-fluorinated organic compounds that have at least one or two functional groups that are capable of reacting with an isocyanate group. Such functional groups include hydroxy, amino and thiol groups. Examples of such organic compounds include aliphatic monofunctional alcohols, e.g., mono-alkanols having at least 1, preferably at least 6 carbon atoms, aliphatic monofunctional amines, a polyoxyalkylenes having 2, 3 or 4 carbon atoms in the oxyalkylene groups and having 1 or 2 groups having at least one Zerewitinoff hydrogen atom, polyols including diols such as polyether diols, e.g., polytetramethylene glycol, polyester diols, dimer diols, fatty acid ester diols, polysiloxane diols and alkane diols such as ethylene glycol and polyamines. Examples of monofunctional alcohols include methanol, ethanol, n-propyl alcohol, isopropyl alcohol, n-butyl alcohol, isobutyl alcohol, t-butyl alcohol, n-amyl alcohol, t-amyl alcohol, 2-ethylhexanol, glycidol and (iso)stearyl alcohol. Fatty ester diols are preferably diols that include an ester function derived from a fatty acid, preferably a fatty acid having at least 5 carbon atoms and more preferably at least 8 carbon atoms. Examples of fatty ester diols include glycerol mono-oleate, glycerol mono-stearate, glycerol mono-ricinoleate, glycerol mono-tallow, long chain alkyl di-esters of pentaerythritol having at least 5 carbon atoms in the alkyl group. Suitable fatty ester diols include RILANIT™ diols such as RILANIT™ GMS, RILANIT™ GMRO and RILANIT™ HE (all commercially available from Henkel).

Suitable polysiloxane diols include polydialkylsiloxane diols and polyalkylarylsiloxane diols. The polymerization degree of the polysiloxane diol is preferably between 10 and 50 and more preferably between 10 and 30. Polysiloxane diols particularly include those that correspond to one of the following formulas: 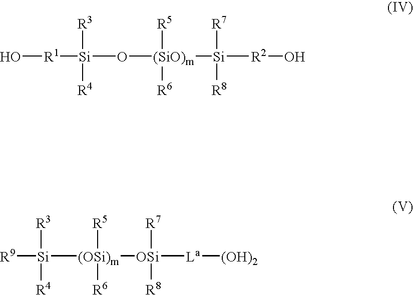
wherein R¹ and R² independently represent an alkylene group having 1 to 4 carbon atoms, R³, R⁴, R⁵, R⁶, R⁷, R⁸ and R⁹ independently represent an alkyl group having 1 to 4 carbon atoms or an aryl group, L^{a} represents a trivalent linking group and m represents a value of 10 to 50. L is for example a linear or branched alkylene group that may contain one or more catenary hetero atoms such as oxygen or nitrogen.

Further suitable diols include polyester diols. Examples include linear UNIFLEX™ polyesters (commercially available from Union Camp) and polyesters derived from dimer acids or dimer diols. Dimer acids and dimer diols are well-known and are obtained by dimerisation of unsaturated acids or diols in particular of unsaturated long chain aliphatic acids or diols (e.g. at least 5 carbon atoms). Examples of polyesters obtainable from dimer acids or dimer diols include PRIPLAST™0 and PRIPOL™ diols (both commercially available from Uniqema).

According to a particularly preferred embodiment, the organic compound will include one or more water solubilizing groups or groups capable of forming water solubilizing groups so as to obtain a fluorinated compound that can more easily be dispersed in water. Additionally, by including water solubilizing groups in the fluorinated compound, beneficial stain release properties may be obtained on the fibrous substrate. Suitable water solubilizing groups include cationic, anionic and zwitterionic groups as well as non-ionic water solubilizing groups. Examples of ionic water solubilizing groups include ammonium groups, phosphonium groups, sulfonium groups, carboxylates, sulfonates, phosphates, phosphonates or phosphinates. Examples of groups capable of forming a water solubilizing group in water include groups that have the potential of being protonated in water such as amino groups, in particular tertiary amino groups. Particularly preferred organic compounds are those organic compounds that have only one or two functional groups capable of reacting with NCO-group and that further include a non-ionic water-solubilizing group. Typical non-ionic water solubilizing groups include polyoxyalkylene groups. Preferred polyoxyalkylene groups include those having 1 to 4 carbon atoms such as polyoxyethylene, polyoxypropylene, polyoxytetramethylene and copolymers thereof such as polymers having both oxyethylene and oxypropylene units. The polyoxyalkylene containing organic compound may include one or two functional groups such as hydroxy or amino groups. Examples of polyoxyalkylene containing compounds include alkyl ethers of polyglycols such as e.g. methyl or ethyl ether of polyethyleneglycol, hydroxy terminated methyl or ethyl ether of a random or block copolymer of ethyleneoxide and propyleneoxide, amino terminated methyl or ethyl ether of polyethyleneoxide, polyethylene glycol, polypropylene glycol, a hydroxy terminated copolymer (including a block copolymer) of ethyleneoxide and propylene oxide, diamino terminated poly(alkylene oxides) such as JEFFAMINE™ ED and JEFFAMINE™ EDR-148 (both commercially available from Huntsman Performance Chemicals) and poly(oxyalkylene) thiols.

The optional co-reactant may also include an isocyanate blocking agent. The isocyanate blocking agent can be used alone or in combination with one or more other co-reactants described above. Blocking agents and their mechanisms have been described in detail in “Blocked isocyanates III.: Part. A, Mechanisms and chemistry” by Douglas Wicks and Zeno W. Wicks Jr., Progress in Organic Coatings, 36 (1999), pp. 14-172. Preferred blocking agents include arylalcohols such as phenols, lactams such as ε-caprolactam, δ-valerolactam, γ-butyrolactam, oximes such as formaldoxime, acetaldoxime, cyclohexanone oxime, acetophenone oxime, benzophenone oxime, 2-butanone oxime or diethyl glyoxime. Further suitable blocking agents include bisulfite and triazoles.

Other suitable fluorochemical topical treatments for use in the present invention include ZONYL™ 7713 or 7040 (commercially available from E. I. DuPont de Nemours & Co.). Preferred fluorochemical melt additives include oxazolidinones such as those described in U.S. Pat. No. 5,099,026.

A variety of hot melt adhesives can be used in the invention. Preferred adhesives include LDPEs, atactic polypropylenes, propylene/1-butene/ethylene terpolymers, and propylene/ethylene, 1-butene/ethylene, and 1-butene/propylene copolymers. Other useful adhesives include those described in U.S. Pat. Nos. 3,932,329, 4,081,415, 4,692,370, 5,248,719, 5,869,5612 and 6,288,149. The adhesive can also be a low basis weight thermoplastic scrim such as SHARNET™ hot melt adhesive web from Bostik-Findley Company. The selection and processing of the hot melt adhesive will be familiar to those skilled in the art. Usually a hot melt adhesive will be present on both sides of the airflow resistive membrane. When adhesive layers are present on both sides of the membrane, the adhesive layers can be the same or different.

A variety of insulating mats and other porous spacing layers can be used in the invention. Preferred spacing layers include those described in U.S. Pat. Nos. 4,837,067, 5,459,291, 5,504,282, 5,749,993, 5,773,375, 5,824,973, 5,866,235, 5,961,904, 6,145,617, 6,296,075, 6,358,592, and Re. 36,323, U.S. Published Patent Application No. US 2001/0036788 A1 and PCT Published Application No. WO 99/44817 A1. Other suitable materials include the cotton and synthetic fiber vinyl acetate copolymers available as “shoddy”, MARATEX™, MARABOND™ or MARABOND5™ from Janesville Products, Inc. The spacing layer can also be a space containing air or other gas. Techniques for fabricating suitable spacing layers will be familiar to those skilled in the art.

The acoustical laminates of the invention can be placed adjacent to (e.g., adhered to) a variety of sound reflective surfaces, such as vehicular floor pans, door panels, headliners, trunks and hoods. Where the spacing layer is air, the acoustical laminate can be placed in suitably spaced relation to a sound reflecting surface so as to provide an appropriately-dimensioned space between the acoustical laminate and the sound reflective surface. Since vehicle space is a limited commodity, sound absorbing materials in vehicles typically are confined to relatively low thicknesses and typically have their greatest effectiveness at about 1000 Hz and above. With this caveat, sound absorption performance is frequency dependent and a single porous absorbing material may not provide optimum sound absorption across an entire frequency domain of interest. A material that has a good sound absorption coefficient at 5000 hertz may not have a good sound absorption coefficient at 100 hertz. When the total depth of the space between the face of a material and a sound reflecting surface behind it is less than about one-fourth of an incident wavelength, the low frequency coefficient of the material decreases with decreasing frequency. Addition of an airflow resistive membrane can significantly enhance low frequency sound absorption performance of a porous absorbing material.

A variety of decorative layers can be employed in the invention. Preferred decorative materials include carpet, fabric, appropriately porous or perforated leather or metal panels, plastic films or sheets. Techniques for fabricating such decorative layers will be familiar to those skilled in the art.

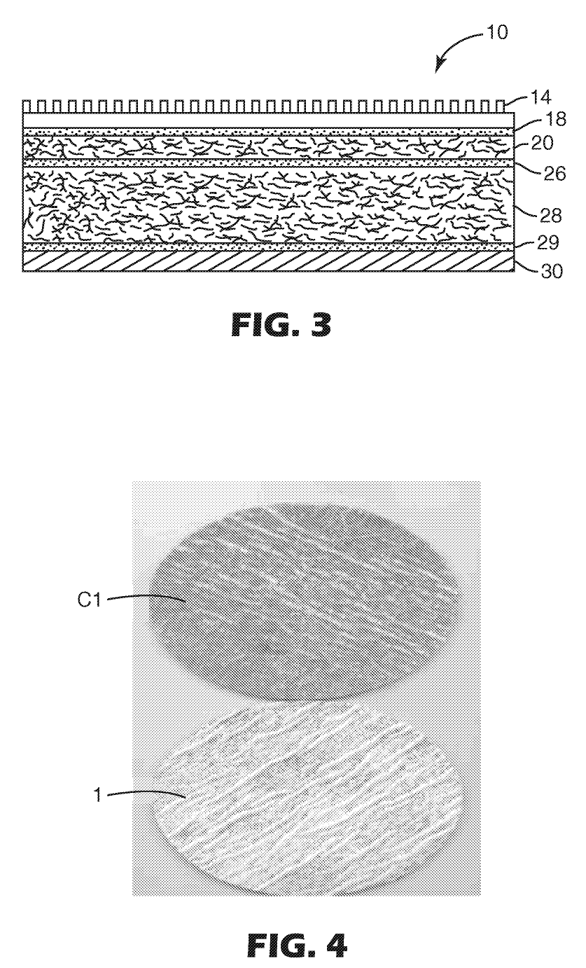

The finished acoustical laminate preferably has an airflow resistance greater than about 1000 mks Rayls and less than about 4200 mks Rayls. In a conventional automotive carpet construction, this corresponds to use of an airflow resistive web whose airflow resistance is about 200 to about 3300 mks Rayls. More preferably, the finished acoustical laminate preferably has an airflow resistance greater than about 10³ mks Rayls and less than about 2×10³ mks Rayls, corresponding to an airflow resistive web whose airflow resistance is about 600 to about 1100 mks Rayls. The airflow resistance of the acoustical laminate will usually be somewhat dependent on the web-forming or extrusion coating techniques used to form individual layers of the acoustical laminate, and upon the molding or laminating techniques used to form the acoustical laminate. This can be better appreciated by reviewing FIG. 3, which is a schematic side view of acoustical laminate 10. Fibers 14 and LDPE hot melt adhesive layers 18 and 26 can be seen in magnified view. The coating weight and thus the thickness of adhesive layers 18 and 26 preferably is controlled or otherwise chosen to provide a suitable balance of interfacial adhesion and porosity in laminate 10. Use of an excessively thick layer 18 or 26 can cause pore plugging to occur when the laminate is molded. Other factors such as variations in molding dwell time, temperature, and the surface energy of adjacent layers on either side of the adhesive bond can all affect porosity in the final laminated article. Reducing the percent add-on of the thermoplastic adhesive layers and altering the molding time or temperature can increase porosity. Adhesive add-on and the porosity of the final laminate can also be regulated by applying initially discontinuous hot melt adhesive layers. For example, adhesive layer 26 can be formed using dot printing or another suitable discontinuous coating technique, or made from the above-mentioned thermoplastic scrim.

This invention can provide an improved acoustical laminate at reduced cost. For example, the sound insulating mat can be made from or can incorporate substantial amounts of recycled fibrous insulating mat manufacturing waste. The waste stream can incorporate recycled shoddy and other materials that typically rely on relatively large fiber diameters to achieve part rigidity and compression resistance at low cost. Such low cost insulating mat materials typically have a large pore size distribution and consequent low airflow resistance and low sound absorption. By recycling such low cost materials into the insulating mat layer of an acoustical laminate of the invention, a premium performance acoustical laminate can be provided at reduced raw material cost. Because the invention facilitates control of pore plugging and selection of an appropriate air pressure drop across the membrane and across the acoustical laminate as a whole, the final sound absorption performance is not especially dependent upon the construction details of the insulating mat. In effect, only the one-quarter wavelength rule and the porosity and interfacial adhesion of the airflow resistant membrane need to be considered. If pore plugging is uncontrolled, then it can be much more difficult to obtain satisfactory lamination, interfacial adhesion and the desired degree of porosity and sound absorption in the final acoustical laminate.

The acoustical laminates of the invention can significantly attenuate sound waves passing, from a source area of a vehicle (e.g., the engine compartment, driveline, wheels, exterior panels or other sources of noise) to a receiving area of the vehicle (e.g., the firewall, floor pan, door panels, headliner or other interior trim). The laminate is positioned between the source area and the receiving area such that a major face of the laminate intercepts and thereby attenuates sound waves passing from the source area to the receiving area. Those skilled in the art will be familiar with a variety of ways in which such the laminates of the invention can be so positioned.

The invention is further illustrated in the following illustrative examples, in which all parts and percentages are by weight unless otherwise indicated.

### EXAMPLE 1 AND COMPARISON EXAMPLE C1

A meltblown web was prepared using ULTRAMID™ BS400N Nylon 6 polyamide resin (commercially available from BASF Corp.) extruded through a 165.1 cm wide meltblowing die having an array of 381 μm die tip orifices spaced on 1016 μm centers. The air knife gap was set to 762 μm and the die tip was recessed 762 μm relative to the die air knives. The collector was spaced 9.53 cm from the meltblowing die. The resin temperature was set to 363° C. in the extruder and the temperature of the die air used for filament attenuation was set to 360° C. at the manifold. The die air manifold pressure was set to 0.052 MPa. The polymer throughput rate was held constant at about 447 g/cm/hour, and the collector was moved at a rate so as to produce a web having a basis weight of about 45 grams/m². The resulting meltblown web had a melting temperature of about 220° C. and a thickness of about 0.18 mm as measured using a micrometer. The measured airflow resistance was 721 mks Rayls as determined using ASTM C522. Normalizing for thickness in meters, the airflow resistivity was calculated to be 4.01×10⁶ Rayls/m.

A 30.5×30.5 cm section of the meltblown web was sprayed with an aqueous dispersion of a fluorochemical urethane prepared by charging a reaction vessel with 58.89 parts C₄F₉SO₂N(CH₃)CH₂CH₂OH (prepared using a procedure essentially as described in Example 1 of U.S. Pat. No. 2,803,656), 0.02 parts dibutyltin dilaurate and 237 parts methylisobutyl ketone. The temperature of the stirred mixture was raised to 60° C. under a dry nitrogen purge. 40 Parts DESMODUR™ N-3300 polyfunctional isocyanate resin (commercially available from Bayer Corporation) was slowly added while maintaining the temperature between 60-65° C. Upon completion of the addition, the reaction mixture was stirred for 1 hour at 60° C. 3.42 Parts 3-aminopropyltriethoxysilane were added dropwise while keeping the reaction mixture below 65° C. The reaction mixture was stirred for 30 minutes. 18.69 Parts solid CARBOWAX™ 1450 polyethylene glycol (commercially available from Dow Chemical Company) were added to the stirred mixture. The reaction was followed to completion via Fourier Transform infrared spectroscopy, as determined by disappearance of the —NCO band at approximately 2289 cm⁻¹. The reaction product was emulsified by vigorously stirring while slowly adding 944 parts 60° C. deionized water. The resulting pre-emulsion mixture was sonically agitated for 2 minutes. The methylisobutyl ketone solvent was stripped from the mixture using a rotary evaporator connected to an aspirator. The resulting emulsion was diluted to 30% active solids in water, and then further diluted with water to 3% active solids prior to spraying. The meltblown web was weighed, sprayed uniformly with the diluted dispersion, and subsequently placed into an oven at 116° C. for approximately 5 minutes. The web was weighed again and found to have a 3.67 wt. % fluorochemical solids add-on or approximately 0.88 wt. % fluorine. The fluorochemically treated web was placed onto a 30.5 cm×30.5 cm piece of SHARNET™ SP091 30 gram/m² hot melt adhesive scrim (commercially available from Bostik-Findley Company) that was in turn placed atop a sound-absorbing mat having a basis weight of about 897 gram/m². The sound-absorbing mat was made from air laid 8-denier polyester staple fiber cohesively bound with a 4-denier copolyester bicomponent fiber.

A 30.5 cm×30.5 cm sample of 767 gram/m² carpet facing material made from nylon tufted into a nylon spunbond nonwoven and backed with LDPE was placed atop the fluorochemically treated web. The backed carpet bad a base and pile height of 5 mm. The resulting carpet-nylon airflow resistive membrane-adhesive web-fibrous insulating mat assembly was compression molded with heat to a thickness of 20 mm. Compression molding was accomplished by placing the assembly onto a 0.46 m×0.46 m×5.7 mm thick aluminum bottom platen bearing a polytetrafluoroethylene release liner to prevent sticking. An identical release liner-coated top platen was placed release liner side down atop the assembly. The platens were gapped to 20 mm to control thickness after oven heating in a simulated molding operation. Weights were placed onto the top platen to insure compression to the 20 mm spacer gap setting. A thermocouple was inserted into the insulating mat to measure the actual temperature during molding. The oven temperature was set to a relatively low value of 204° C. This provided a lengthy dwell time before the insulating mat thermocouple indicated an internal temperature of 170° C. and thus facilitated potential adhesive wetting into the airflow resistive membrane. Upon obtaining a 170° C. internal temperature, the molded assembly was removed from the oven and allowed to cool to room temperature. The molded assembly was carefully delaminated to separate the insulating mat from the carpet-airflow resistive membrane laminate. The remaining adhered fibers were meticulously removed from the airflow resistive membrane and the height of the carpet-airflow resistive membrane laminate was measured using a ruler. This allowed a visual observation of the degree of adhesive penetration or wetting into the airflow resistive membrane. The carpet-airflow resistive membrane laminate was placed into an airflow chamber with the carpet backing facing the airflow in order to measure airflow resistance.

In a comparison run, a similar carpet-nylon airflow resistive membrane-adhesive web-fibrous insulating mat assembly was prepared but without using a fluorochemical treatment on the airflow resistive membrane. Following compression molding and delamination as described above, the insulating mat and carpet-airflow resistive membrane laminate were delaminated and the height and airflow resistance of the carpet-airflow resistive membrane laminate were evaluated. The results using both the fluorochemically-treated and untreated airflow resistive membranes are set out below in Table 1.

TABLE 1

| | | Airflow | Airflow |
|---|---|---|---|
| | | Resistance, | Resistivity, |
| Example | Thickness, mm | MKS Rayls | Rayls/m |
| Example 1 | 5 | 3,345 | 669,000 |
| (fluorochemically treated | | | |
| airflow resistive membrane) | | | |
| Comparison Example C1 | 5 | 18,888 | 3,777,600 |
| (untreated airflow resistive | | | |
| membrane) | | | |

The data in Table 1 shows that the treated airflow resistive membrane had substantially lower airflow resistance than the untreated membrane, indicating that much greater pore plugging occurred when laminating the untreated membrane. However, when the laminates were manually pulled apart to separate the layers, the adhesion between the carpet layer and treated membrane was roughly the same as the adhesion between the carpet layer and untreated membrane. Visual examination of the delaminated insulation pad-membrane interface side of the treated and untreated membranes showed that the treated membrane was white in color (indicating minimal penetration and pore plugging by the thermoplastic adhesive) whereas the untreated membrane was dark in color (indicating appreciable membrane penetration, pore plugging and saturation by the thermoplastic adhesive). FIG. 4 shows a photograph of the untreated membrane C1 and the treated membrane 1 illustrating this difference.

In further comparison runs, the insulating mat used in Example 1 was heated to 170° C. in the above-described molding press while being compressed to a 15 mm thickness. This matched the insulating mat thickness obtained after molding the above-described carpet-nylon airflow resistive membrane-adhesive web-fibrous insulating mat assembly to a 20 mm thickness. The compressed 15 mm mat was allowed to cool, identified as Comparison Example C2 and evaluated for normal incidence sound absorption coefficient in accordance with ASTM E-1050 for several frequencies of interest using a mid-size impedance tube (63 mm diameter tube). A sample of the nylon tufted carpet used in Example 1 was similarly heated to 170° C. in the above-described molding press while being compressed to a 5 mm thickness. This permitted capillary flow of the LDPE hot melt adhesive to take place, thereby imparting porosity and air permeability to the carpet. The molded carpet was allowed to cool, identified as Comparison Example C3 and evaluated for normal incidence sound absorption coefficient. Next, samples of the insulating mat and nylon tufted LDPE-backed carpet were assembled without an intervening airflow resistive membrane and carefully laminated in the above-described molding press while being compressed to a 20 mm thickness. Several attempts were required to obtain a molded laminate having the right degree of porosity after cooling. The best sample was identified as Comparison Example C4 and evaluated for normal incidence sound coefficient. Superior sound absorption was obtained using an acoustical laminate of the invention containing a fluorochemically-treated membrane, and much less care was required during molding than was the case when using an untreated membrane.

### EXAMPLE 2 AND COMPARISON EXAMPLES C2 AND C3

The meltblown web of Example 1 web was plasma fluorinated using perfluoropropane at 2000 watts and 300 millitorr pressure. The dwell time or dosage was set to provide a web with a 3 oil repellency rating in accordance with AATCC 118-1997 or ISO 14419 and a 0.16% fluorine content. The percent fluorine was measured by placing 0.07 to 0.09 grams of the fluorinated web sample into a gelatin capsule and placing the capsule inside a cylinder formed from platinum wire electrodes. 15 ml of deionized water was placed into a dry 1000 ml polycarbonate flask. The flask was purged for 30 seconds with oxygen followed by immediately placing the platinum electrode into the flask and clamping to provide a seal. The flask was inverted and placed into a support ring standing at a slight inclined angle while ensuring that the sample remained dry. The platinum wires were connected to a variable power source. The power source was turned on and the voltage increased until the sample ignited. After complete combustion, the power source was turned off and the flask was vigorously shaken for 1 to 2 minutes ensuring that the platinum cylinder was thoroughly rinsed. The flask was allowed to sit for 30 minutes with occasional shaking. A 5 ml sample was pipetted from the combustion flask along with 5 ml of Total Ionic Strength Adjuster Buffer (TSIAB IV) buffer solution into a 50 ml beaker. The TSIAB IV solution had been prepared by combining 500 ml deionized water, 84 ml concentrated HC1 (36-38%), 242 grams tris-hydroxymethyl amino methane and 230 grams sodium tartrate, and diluting the resulting mixture with deionized water to provide one liter of buffer solution. A model 94-09 fluoride electrode analyzer (commercially available from Orion Research Inc.) was placed into the 50 ml beaker. Stirring was accomplished using a model DP-4443 ion stir apparatus (commercially available from Sienco Inc.). The fluoride amount in the sample was recorded in micrograms using a model 940 EA microprocessor (commercially available from Orion Research Inc.). The fluoride concentration was calculated by dividing the micrograms of fluoride by the sample weight.

The fluorine-treated web had an airflow resistance of 779 MKS Rayls when measured according to ASTM C522. The airflow resistivity was calculated by normalizing for thickness in meters, yielding a resistivity of 4.33×10⁶ Rayls per meter. A 30.5 cm×30.5 cm sample of the resulting fluorine-treated airflow resistive membrane was laminated into a carpet/fluorine-treated airflow resistive membrane/adhesive web/fibrous insulating mat assembly using the method of Example 1 but with an oven temperature of 257° C. Upon obtaining an actual laminate temperature of 170° C., the molded acoustical laminate was removed from the oven and allowed to quench to room temperature. The laminate was measured for airflow resistance in accordance with ASTM C522 with the sample oriented carpet side up in the test chamber. The sample was subsequently removed from the chamber and the components were meticulously separated. The insulation pad and the molded carpet were separately analyzed for airflow resistance. The airflow value for the fluorine-treated airflow resistive membrane before molding was summed with the airflow values of the remaining components after molding and compared with the airflow resistance of the completed molded acoustical laminate. The observed difference in the completed laminate airflow value from the summed airflow value for the individual components can be attributed to adhesion in the form of pore plugging in the airflow resistive membrane.

In Comparison Example C2, a carpet/airflow resistive membrane/adhesive web/fibrous insulating mat assembly was similarly prepared but without using a plasma fluorination treatment on the airflow resistive membrane. The laminate was tested in the manner described above.

In Comparison Example C3, a carpet/adhesive web/fibrous insulating mat assembly was prepared but without using an airflow resistive membrane. The laminate was tested in the manner described above.

Table 2 shows the beneficial effects of the plasma fluorination treatment. Molding caused only a relatively modest decrease in porosity and increase in airflow resistance. Without the treatment, porosity decreased substantially and airflow resistance increased substantially after molding. Without the membrane, airflow resistance remained too low for effective noise suppression. Despite the presence of the fluorochemical treatment, the laminate interlayer adhesion was very comparable (as qualitatively evaluated using hand-separated samples) to the interlayer adhesion of Comparative Example C3 which had no airflow resistive membrane.

TABLE 2

| | | Airflow |
|---|---|---|
| | | Resistance, |
| Example | Thickness, mm | MKS Rayls |
| Example 2: | | |
| Molded carpet/fluorine-treated airflow | 20 | 2,212 |
| resistive membrane/adhesive | | |
| web/fibrous insulating mat assembly | | |
| Components: | | |
| Carpet after molding | 4 | 813 |
| Fluorine-treated membrane before | 0.18 | 779 |
| molding | | |
| Insulation pad after molding | 15 | 199 |
| Sum of Components: | Approx. 20 | 1,791 |
| % Increase in Airflow Resistance due | | 24 |
| to pore plugging | | |
| Increase in Rayls due to pore | | 421 |
| plugging | | |
| Comparison Example C2: | | |
| Molded carpet/airflow resistive | 20 | 11,921 |
| membrane/adhesive web/fibrous | | |
| insulating mat assembly | | |
| Components: | | |
| Carpet after molding | 4 | 813 |
| Membrane before molding | 0.18 | 774 |
| Insulation pad after molding | 15 | 194 |
| Sum of Components: | Approx. 20 | 1,781 |
| % Increase in Airflow Resistance due | | 569% |
| to pore plugging | | |
| Increase in Rayls due to pore | | 10,140 |
| plugging | | |
| Comparison Example C3: | | |
| Molded carpet/adhesive web/fibrous | 20 | 588 |
| insulating mat assembly | | |
| Components: | | |
| Carpet after molding | 4 | 427 |
| Insulation pad after molding | 15.3 | 196 |
| Sum of Components: | Approx. 20 | 623 |
| % Increase in Airflow Resistance due | | N.A.¹ |
| to pore plugging | | |
| Increase in Rayls due to pore | | N.A. |
| plugging | | |

¹“N.A.” means not applicable.

### EXAMPLE 3 AND COMPARISON EXAMPLE C4

A meltblown web was prepared using Type 305 0.78 intrinsic viscosity polybutylene terephthalate (PBT) resin (commercially available from Intercontinental Polymers Inc.). The resin was extruded through a 165.1 cm wide meltblowing die having an array of 305 μm die tip orifices spaced on 498 μm centers. The air knife gap was set to 406 μm and the die tip was advanced 635 μm relative to the air knife. The collector was spaced 10.16 cm from the meltblowing die. The resin temperature was set to 321° C. in the last extruder zone. The resin temperature in the meltblowing die was set to an averaged zone temperature of 312° C. and the temperature of the die air used for filament attenuation was set to 320° C. at the manifold. The die air manifold pressure was set to approximately 0.05 MPa. The throughput rate of the polymer was held constant at about 357 g/cm/hour, and the collector was moved at a rate so as to produce a web having a basis weight of about 60 g/m². A No. PE120-30 thermoplastic adhesive web (commercially available from Bostik-Findley Company) was point bonded to the PBT web at 141° C. using a patterned steel roll bearing against a rubber-surfaced roll with a force of about 40 Kg per lineal cm. The resulting meltblown web's average melting temperature was about 230° C. and its thickness was about 0.4 mm as measured using a micrometer.

A reaction vessel was charged with 34.8 parts of the oligomeric alcohol CF₃CF₂CF₂O(CF(CF₃)CF₂O)_{3.6}CF(CF₃)CONHCH₂CH₂OH, 0.9 parts C₄F₉SO₂N(CH₃)CH₂CH₂OH, 2 parts methoxypolyethylene glycol (molecular weight 750) and 50 parts methyl isobutyl ketone. 10.1 Parts tris(6-isocyanatohexyl)isocyanurate were added and the mixture was heated to 75° C. under nitrogen with stirring. 0.03 Parts dibutyl tin dilaurate were then added to the resulting cloudy mixture. An exothermic reaction began, and the temperature rose to ˜90° C. When the exotherm subsided the reaction was heated at 75° C. for three hours. 2.3 Parts CH₃C(═NOH)C₂H₅ were added dropwise while the vessel was rinsed with 2 parts methyl isobutyl ketone. The reaction mixture was stirred at 75° C. overnight under nitrogen. The next day a solution of 8.3 parts 30% aqueous methyl polyoxyethylene(15)octadecyl ammonium chloride in 219.2 parts deionized water was added while keeping the temperature above 70° C. during the addition. The ensuing mixture was sonically agitated for five minutes. The methyl isobutyl ketone was removed by heating under reduced pressure using a rotary evaporator. This yielded a white dispersion of a fluorochemical urethane.

The meltblown web was topically fluorochemically treated by applying the fluorochemical to the web's surface at a 0.3 percent solids (0.12 percent fluorine add-on) level in a padding operation followed by oven drying at 149° C. The resulting treated web provided a 6-oil repellency rating in accordance with AATCC 118-1997 or ISO 14419. The treated web had an airflow resistance of 823 MKS Rayls and a thickness-normalized airflow resistivity of 2.06 10⁶ Rayls per meter.

The treated web was used to form a compression molded carpet/fluorine-treated airflow resistive membrane/adhesive web/fibrous insulating mat laminate using the method of Example 2. The resulting Example 3 laminate was evaluated for thickness and airflow resistance using the method of Example 1. A similar laminate was prepared but without using a topical fluorochemical treatment on the airflow resistive membrane. The resulting Comparison Example C4 laminate was similarly evaluated for thickness and airflow resistance.

Table 3 shows the beneficial effects of the topical fluorination treatment. Molding caused only a relatively modest decrease in porosity and increase in airflow resistance. Without the treatment, porosity decreased substantially and airflow resistance increased substantially after molding. Despite the presence of the fluorochemical treatment, the laminate interlayer adhesion was very comparable (as qualitatively evaluated using hand-separated samples) to the interlayer adhesion of Comparative Example C3 which had no airflow resistive membrane.

TABLE 3

| | | Airflow |
|---|---|---|
| | | Resistance, |
| Example | Thickness, mm | MKS Rayls |
| Example 3: | | |
| Molded carpet/fluorine-treated airflow | 23 | 2,169 |
| resistive membrane/adhesive | | |
| web/fibrous insulating mat assembly | | |
| Components: | | |
| Carpet after molding | 4 | 1248 |
| Fluorine-treated membrane before | 0.5 | 823 |
| molding | | |
| Insulation pad after molding | 18 | 270 |
| Sum of Components: | Approx. 23 | 2,341 |
| % Increase in Airflow Resistance due | | N.A. |
| to pore plugging | | |
| Increase in Rayls due to pore | | −172 |
| plugging | | |
| Comparison Example C4: | | |
| Molded carpet/airflow resistive | 23 | 3,951 |
| membrane/adhesive web/fibrous | | |
| insulating mat assembly | | |
| Components: | | |
| Carpet after molding | 4 | 1248 |
| Membrane before molding | 0.5 | 909 |
| Insulation pad after molding | 18 | 183 |
| Sum of Components: | Approx. 20 | 2340 |
| % Increase in Airflow Resistance due | | 69% |
| to pore plugging | | |
| Increase in Rayls due to pore | | 1,611 |
| plugging | | |

The fluorochemical treatment in Example 3 exhibited ver high oil repellency and yielded a negative pore plugging value.

### EXAMPLE 4 AND COMPARISON EXAMPLE C5 AND C6

A meltblown web was prepared using Type 305 0.78 intrinsic viscosity PBT resin. The resin was extruded through a 48.3 cm wide meltblowing die having an array of 20 orifices per cm. The orifices had an average hydraulic diameter of 288.6 μm. The air knife gap was set to 381.0 μm and the die tip was advanced 431.8 μm relative to the air knife. The collector was spaced 15.9 cm from the meltblowing die. The extruder temperature profile and die temperature was set to 330° C. The temperature of the die air used for filament attenuation was set to 420° C. at the header. The die air manifold pressure was set to approximately 0.06 MPa. The throughput rate of the polymer was held constant at about 536 g/cm/hour, and the collector was moved at a rate so as to produce a web having a basis weight of about 66 g/m². The web was embossed with approximately a 20% diamond patterned steel roll against a smooth steel roll. Both rolls were set to 141° C. and the web was processed at 3.05 meters/min at about 69 Kg per lineal cm. The resulting meltblown web's average melting temperature was about 230° C. and its thickness was about 0.6 mm as measured using a micrometer.

The web was topically fluorochemically treated by applying the fluorochemical urethane:
α,ω-C₃₆H₇₂[OCOC₂H₄S{CH₂CH(CO₂(CH₂)₂N(CH₃)SO₂C₄F₉)}₄CH₂CH₂(CO₂C₁₈H₃₇)]₂
   at a 0.6 percent solids (0.24 percent fluorine add-on) level in a padding operation followed by oven drying at 149° C. The resulting web provided a 6-oil repellency rating in accordance with AATCC 118-1997 or ISO 14419. The treated web had an airflow resistance of 1030 MKS Rayls and a thickness-normalized airflow resistivity of 1.72 10⁶ Rayls per meter.

The treated web was used to form a compression molded carpet/fluorine-treated airflow resistive membrane/adhesive web/fibrous insulating mat laminate using the method of Example 2. The carpet had a backing and pile height of 7 mm and a basis weight of 1.2 kg/m². The adhesive web was No. PE120-30 (commercially available from Bostik-Findley Company). The resulting Example 4 laminate was evaluated for thickness and airflow resistance using the method of Example 1. A similar laminate Comparison Example C5 was prepared without the use of an airflow resistive membranes. Lastly, another similar laminate, Comparison Example C6 was prepared using an airflow resistive membrane, but without using a topical fluorochemical treatment. The acoustic laminates of Comparison Examples C5 and C6 were also evaluated for thickness and airflow resistance.

Table 4 shows the beneficial effects of the topical fluorination treatment. Molding caused only a relatively modest decrease in porosity and increase in airflow resistance. Without the treatment, porosity decreased substantially and airflow resistance increased substantially after molding. Despite the presence of the fluorochemical treatment, the laminate interlayer adhesion was very good and exceeded the interlayer adhesion of Comparative Example C5, which had no airflow resistive membrane. Laminate adhesion was assessed qualitatively by simply hand separating the samples.

TABLE 4

| | | Airflow |
|---|---|---|
| | | Resistance, |
| Example | Thickness, mm | MKS Rayls |
| Example 4: | | |
| Molded carpet/fluorine-treated airflow | 26 | 1,758 |
| resistive membrane/adhesive | | |
| web/fibrous insulating mat assembly | | |
| Components: | | |
| Carpet after molding | 7 | 167 |
| Fluorine-treated membrane before | 0.6 | 1,030 |
| molding | | |
| Insulation pad after molding | 18 | 193 |
| Sum of Components: | Approx. 26 | 1,390 |
| % Increase in Airflow Resistance due | | 26% |
| to pore plugging | | |
| Increase in Rayls due to pore | | 368 |
| plugging | | |
| Comparison Example C5: | | |
| Molded carpet/fibrous insulating mat | 26 | 468 |
| assembly | | |
| Components: | | |
| Carpet after molding | 7 | 321 |
| Insulation pad after molding | 19 | 167 |
| Sum of Components: | Approx. 26 | 488 |
| Comparison Example C6: | | |
| Molded carpet/airflow resistive | 26 | 2,662 |
| membrane/adhesive web/fibrous | | |
| insulating mat assembly | | |
| Components: | | |
| Carpet after molding | 7 | 301 |
| Membrane before molding | 0.6 | 1,230 |
| Insulation pad after molding | 19 | 167 |
| Sum of Components: | Approx. 26 | 1,698 |
| % Increase in Airflow Resistance due | | 57% |
| to pore plugging | | |
| Increase in Rayls due to pore | | 964 |
| plugging | | |

Various modifications and alterations of this invention will be apparent to those skilled in the art without departing from the scope and spirit of this invention. This invention should not be restricted to that which has been set forth herein only for illustrative purposes.

1. A porous laminate comprising a discontinuous hot melt adhesive layer adhered to a semipermeable low surface energy airflow resistive porous membrane whose pores are substantially impenetrable by the adhesive.

2. A porous laminate according to claim 1 wherein the porous membrane has a surface energy less than about 34 dynes/cm² and an acoustical airflow resistance between about 200 mks Rayls and about 3300 mks Rayls.

3. A porous laminate according to claim 1 wherein the porous membrane has a surface energy less than about 34 dynes/cm² and an acoustical airflow resistance between about 600 mks Rayls and about 1100 mks Rayls.

4. A sound-absorbing laminate having a porous sound-absorbing spacing layer adjacent to a semipermeable airflow resistive membrane that is substantially impenetrable by molten polyethylene.

5. A sound-absorbing laminate according to claim 4 wherein the airflow resistive membrane has an acoustical airflow resistance between about 200 mks Rayls and about 3300 mks Rayls.

6. A porous laminate comprising a thermoplastic adhesive layer adjacent to a semipermeable fluorochemically-treated airflow resistive membrane.

7. A porous laminate according to claim 6 wherein the adhesive comprises a polyolefin and the airflow resistive membrane comprises a meltblown polyamide or polyester nonwoven web having an acoustical airflow resistance between about 200 mks Rayls and about 3300 mks Rayls.

8. A porous laminate according to claim 6 wherein the adhesive comprises low density polyethylene and the airflow resistive membrane comprises a meltblown polybutylene terephthalate web having an acoustical airflow resistance between about 200 mks Rayls and about 3300 mks Rayls.

9. A sound-modifying structure comprising a sound-reflecting surface spaced from a semipermeable sound modifying laminate comprising a facing layer and a porous membrane that is substantially impenetrable by molten polyethylene.

10. A sound-modifying structure according to claim 9 wherein the facing layer comprises carpet, the membrane comprises a fluorochemical and has an acoustical airflow resistance between about 200 mks Rayls and about 3300 mks Rayls, and the laminate further comprises fibrous material between the sound-reflecting surface and the membrane.

11. A sound-modifying structure according to claim 10 wherein the fibrous material comprises recycled shoddy.

12. A vehicular sound-absorbing structure comprising a decorative layer backcoated with a discontinuous hot melt adhesive layer adhered to a fluorochemically-treated nonwoven airflow resistive membrane having an airflow resistance between 50 and 5000 mks Rayls.

13. A carpet comprising fibers tufted into a backing backcoated with a discontinuous hot melt adhesive layer adhered to a fluorochemically-treated nonwoven airflow resistive membrane having an airflow resistance between 50 and 5000 mks Rayls.

14. An acoustical laminate comprising:
a fibrous or open cell foam underlayment,
a hot melt adhesive layer,
a fluorochemically-treated nonwoven airflow resistive membrane having an airflow resistance between 50 and 5000 mks Rayls,
a hot melt adhesive layer, and
a decorative layer.

15. A headliner, trunk liner, hood liner, instrument panel liner or carpet according to claim 14.

16. A nonwoven acoustic insulating laminate, the laminate comprising at least a porous membrane which has been treated so that it has a surface energy less than about 34 dynes/cm², and at least a layer of fibrous material or open cell foam, the laminate being positioned in a vehicle such that the laminate attenuates sound waves passing from a source area to a receiving area in the vehicle.

17. The acoustic insulating laminate of claim 16 wherein the porous membrane comprises a meltblown web.

18. The acoustic insulating laminate of claim 16 wherein the porous membrane has been treated by topically applying a fluorochemical.

19. The acoustic insulating laminate of claim 16 wherein the porous membrane has been treated by topically applying an organosilicone.

20. The acoustic insulating laminate of claim 16 wherein the porous membrane has been treated by melt addition of a fluorochemical.

21. The acoustic insulating laminate of claim 16 wherein the porous membrane has been treated by plasma fluorination.

22. The acoustic insulating laminate of claim 16 wherein the porous membrane has a surface energy less than about 30 dynes/cm².

23. The acoustic insulating laminate of claim 16 wherein the porous membrane has a surface energy less than about 28 dynes/cm².

24. The acoustic insulating laminate of claim 16 wherein the fibrous material comprises a shoddy layer.

25. The acoustic insulating laminate of claim 16 wherein the laminate further comprises a decorative layer comprising at least one of leather, metal, and plastic.

26. A method for attenuating transmitted sound waves passing from a source area to a receiving area of a vehicle, the method comprising:
a) providing a nonwoven acoustic insulating laminate, wherein the laminate comprises at least one nonwoven web which has been treated so that it has a surface energy less than about 34 dynes/cm², and at least a layer of fibrous material or open cell foam, and
b) positioning the laminate so that it attenuates sound waves passing from the source area to the receiving area.

27. The method of claim 26 wherein the porous membrane comprises a meltblown web.

28. The method of claim 26 wherein the porous membrane has been treated by at least one of:
topical application of a fluorochemical,
topical application of an organosilicone,
melt addition of a fluorochemical, and
plasma fluorination.

29. Tee method of claim 26 wherein the porous membrane has a surface energy less than about 30 dynes/cm².

30. The method of claim 26 wherein the porous membrane has a surface energy less than about 28 dynes/cm².

31. The method of claim 26 wherein the fibrous material comprises a shoddy layer.

32. The method of claim 26 wherein the laminate further comprises a decorative layer comprising at least one of porous leather, perforated leather, porous metal, perforated metal, porous plastic, and perforated plastic.
